(19) United States
(12) Patent Application Publication
(10) Pub. No.: US 2009/0088250 A1
(43) Pub. Date: Apr. 2, 2009

(54) VIDEO GAME DEVICE WITH INTERCHANGEABLE BODY, INTERCHANGEABLE CONTROLLER, AND METHODS OF USE

(75) Inventors: Edwin B. Carlson, Princeton, MA (US); David W. Rhodes, Bolton, MA (US); Clotilde Grimault, Somerville, MA (US); Evan Isaac Timerding Gant, Medford, MA (US); Gregor Mittersinker, Warwick, RI (US)

Correspondence Address: BOWDITCH & DEWEY, LLP, 311 MAIN STREET, P.O. BOX 15156, WORCESTER, MA, 01615-0156, US

(73) Assignee: E.B. CARLSON MARKETING, INC., PRINCETON, MA (US)

(21) Appl. No.: 12/181,747

(22) Filed: Jul. 29, 2008

Related U.S. Application Data
(60) Provisional application No. 60/952,586, filed on Jul. 29, 2007.
(60) Provisional application No. 61/082,465, filed on Jul. 21, 2008.

(51) Int. Cl. A63F 13/02

(52) U.S. Cl. 463/37

(57) ABSTRACT

An improved video game device that is operable with a variety of music-oriented video game platforms that can provide, among other things, improved responsiveness and directional sensitivity, as well as the ability to interchange video game bodies and/or game platform controllers.

### RELATED CASES

Priority is claimed herein to U.S. Provisional Patent Application No. 60/952,586, which was filed on Jul. 29, 2007, and to U.S. Provisional Patent Application No. 61/082,465, which was filed on Jul. 21, 2008, both of which are incorporated herein by reference in their entirety.

### TECHNICAL FIELD

The present disclosure is related to an improved video game device, and in particular, to an improved video game device that is operable with music oriented video game platforms.

### BACKGROUND

A dedicated video game console is a specific computer-based device that executes only video game software that is programmed on a memory chip mounted within an insertable plastic cartridge or on a CD-ROM. The images and sounds generated by the game are output to a television for display to the user in a manner well known in the art. Various manufacturers make and sell dedicated game consoles that have proprietary, rather than industry-standard, interfaces and protocols that are not interchangeable with each other. For example, WII®, GUITAR HERO®, and PLAYSTATION®, each market game consoles that have different standards and interfaces that are not electrically or physically compatible with each other.

The user is provided with an input/output device called a video game controller to interact with the game program and cause certain events to occur. The video game controller may be a keyboard, steering wheel, foot pedals, joystick, trackball or musical instrument which is connected to an input port of the game console for dedicated console applications. The user maintains control over the video program via signals sent from the video game controller, which are derived in response to the selection or setting of a variety of switches, buttons, dials, and triggers located on the video game controller.

Many video game controllers are limited because they are designed and manufactured to interface with a single, dedicated game console platform. Thus, once the user has purchased a particular video game controller, it can only be used with the gaming platform with which it is configured (both electrically and physically) to operate. If the gaming platform becomes obsolete, then the video game controller also becomes obsolete because it cannot be used with other gaming platforms due to the different electrical and physical interfaces.

A need exists in the art for a video game device that can be adapted for use with a variety of different gaming platforms and or controller bodies.

### SUMMARY

The present disclosure is directed to, in one embodiment, a video game device, comprising an electronic subassembly comprising a controller, the controller comprising a selected video game platform adapted to interface with a game console; a body comprising a region configured and dimension to receive at least a portion of the controller; at least one game actuator device electrically coupled to the controller and adapted to trigger a gaming action upon actuation; and a source of power disposed in the controller. The electronic subassembly and/or controller can be detachably connected to the body.

In another embodiment, the present disclosure is directed to a video game device, comprising: an electronic subassembly comprising a controller, the controller comprising a selected video game platform adapted to interface with a game console; a body comprising a region configured and dimension to receive at least a portion of the controller; at least two spaced apart sensors electrically coupled to the controller and defining a detecting region, adapted to trigger a gaming action upon interruption of a signal between the at least two spaced apart sensors; and a source of power disposed in the controller. The video game device can comprise a raised region disposed between the at least two spaced apart sensors. The controller can be adapted to determine the direction of a user's strumming motion from the signals generated by the pair of photo-emitters.

In yet another embodiment, the disclosure is directed to a video game device, comprising an electronic subassembly comprising a controller, the controller comprising a selected video game platform adapted to interface with a game console; a body comprising a region configured and dimension to receive at least a portion of the controller; a strum bar; a special function actuation device disposed on the controller; and a source of power disposed in the controller. The special function actuation device can be disposed adjacent to the strum bar, and spaced apart from the strum bar by about ⅛ inch to about 1 inch.

### BRIEF DESCRIPTION OF THE DRAWINGS

Referring now to the figures, which are exemplary embodiments, and wherein like elements are numbered alike:

FIG. 1 is a perspective view of an exemplary video game device according to one embodiment of the disclosure;

FIG. 2 is an exploded view of the device shown in FIG. 1, showing the body, controller, neck and headstock;

FIG. 3 is a perspective view of the neck and headstock of the video game device shown in FIG. 1, showing the connector at the base of the neck;

FIG. 4 is an exploded view of the connector shown in FIG. 3;

FIG. 5 is a perspective view of the video game device shown in FIG. 1, showing the recessed region in the body, and the connector to the effect selector switch;

FIG. 6 is a back view of the body of the video game device shown in FIG. 1, in which the connector is shown in phantom;

FIG. 7 is an expanded front perspective view of the controller shown in FIG. 2;

FIG. 8 is a front of the controller shown in FIG. 7;

FIG. 9 is a top end view of the controller shown in FIG. 7;

FIG. 10 is a bottom end view of the controller shown in FIG. 7;

FIG. 11 is a back side of the controller shown in FIG. 7;

FIG. 12 is an expanded perspective view of the connectors used to connect the controller and the neck of the video game device shown in FIG. 1;

FIG. 13 is a cross-sectional view the video game device shown in FIG. 1, showing the recessed region defined in the body;

FIG. 14 is a cross-sectional view of the body of the video game device shown through line 13-13 of FIG. 6, showing the assembly of the controller and body;

FIG. 15 is a cross-sectional view of the body of the video game device shown in FIG. 1, showing the controller disposed in the recessed region;

FIG. 16 is an exploded view of an exemplary video game device according to another embodiment of the disclosure, including a sensory region;

FIG. 17 is an illustration of one embodiment of an optical strum bar comprising a spaced apart optical emitter and receiver, showing interruption of the light signal by a user's hand;

FIG. 18 is an illustration of another embodiment of an optical detector comprising pair of spaced apart optical emitters and receivers;

FIG. 19 is an illustration of a magnetic sensor and a magnetized object being moved through the detection zone of the magnetic sensor;

FIG. 20 is an illustration of a raised region that can be disposed in the sensor region;

FIG. 21 is an illustration of a horizontally oriented linear detection zone for an optical strum bar, created with a pair of Hall-effect sensors;

FIG. 22 is an illustration of a horizontally oriented linear detection zone for an optical strum bar, created with an orthogonal array of Hall-effect sensors;

FIG. 23 is an illustration of a vertically oriented linear detection zone for an optical strum bar, created with an orthogonal array of Hall-effect sensors; and

FIG. 24 is an illustration of an actuator disposed on the strum region of the guitar shown in FIG. 16.

### DETAILED DESCRIPTION OF EXEMPLARY EMBODIMENTS

The present disclosure is directed to an improved video game device that is operable with a variety of music-oriented video game platforms that can provide, among other things, improved responsiveness and directional sensitivity, as well as the ability to interchange video game bodies and/or game platform controllers.

According to one aspect of the disclosure, the video game device comprises a body with a recessed region adapted to receive and couple to an interchangeable electronic housing. The electronic housing can comprise a controller for a selected video game platform, which would be understood by those skilled in the art, and which can be interchanged with a variety of bodies (e.g., bass guitar body, and the like) comprising a corresponding recessed region. The interchangeable body and/or electronic housing provides users with the flexibility to purchase various electronic housings, each containing controllers for different game platforms (e.g., Wii, Guitar Hero, Playstation, and the like), and to use each of them with a single body (e.g., a bass guitar body). Alternatively, or additionally, a user can purchase various instrument bodies (e.g., bass guitar body, and the like), to use with an electronic housing containing a controller for a game platform controller (e.g., Wii, Guitar Hero, or Playstation, and the like), and to use the same game platform controller in the various bodies.

According to another aspect of the disclosure, the video game device can comprise one or more sensors for detecting motion (such as strumming), directly or indirectly. The one or more sensors can be disposed singly, in pairs, in various arrays and/or combinations at various locations on the guitar. Suitable sensors include, but are not limited to, light sensors (such as optical sensors), transducer sensors (such as Hall-effect sensors), capacitative sensors, pressure sensors, and the like, and combinations comprising at least one of the foregoing.

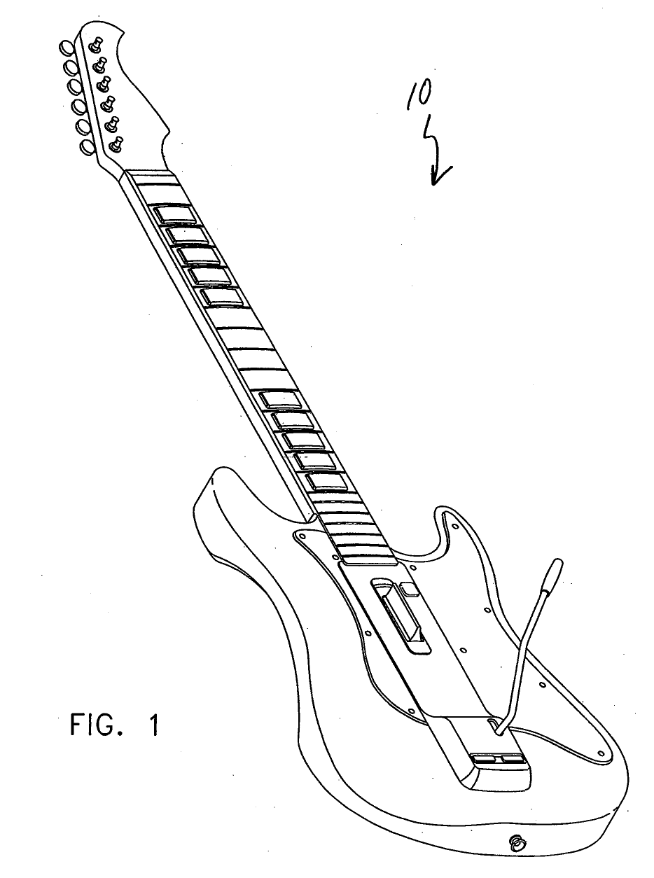

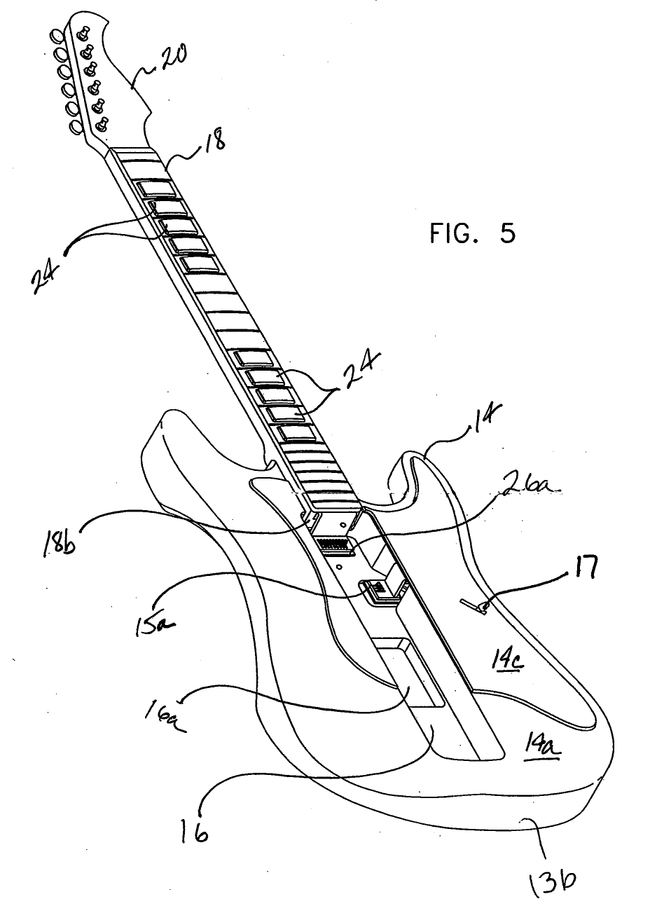

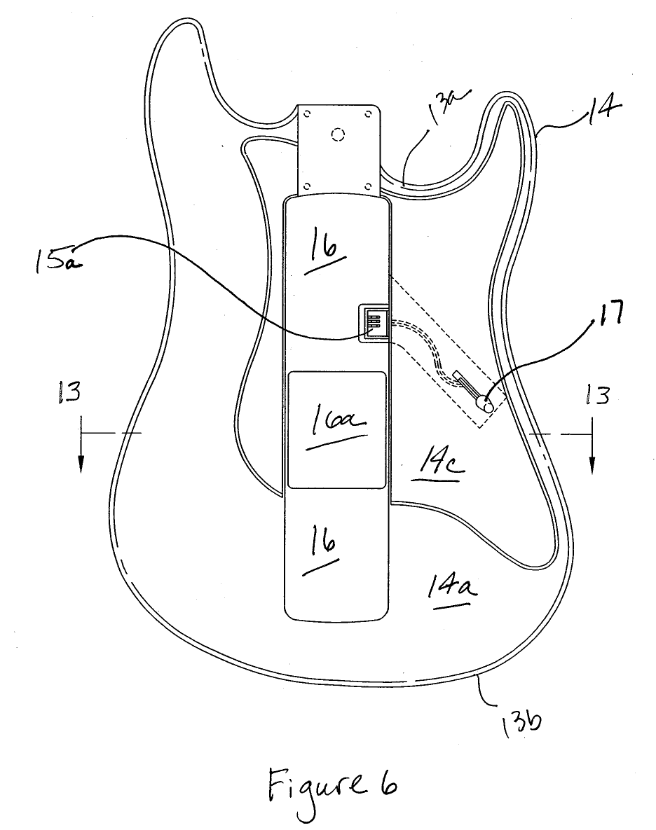

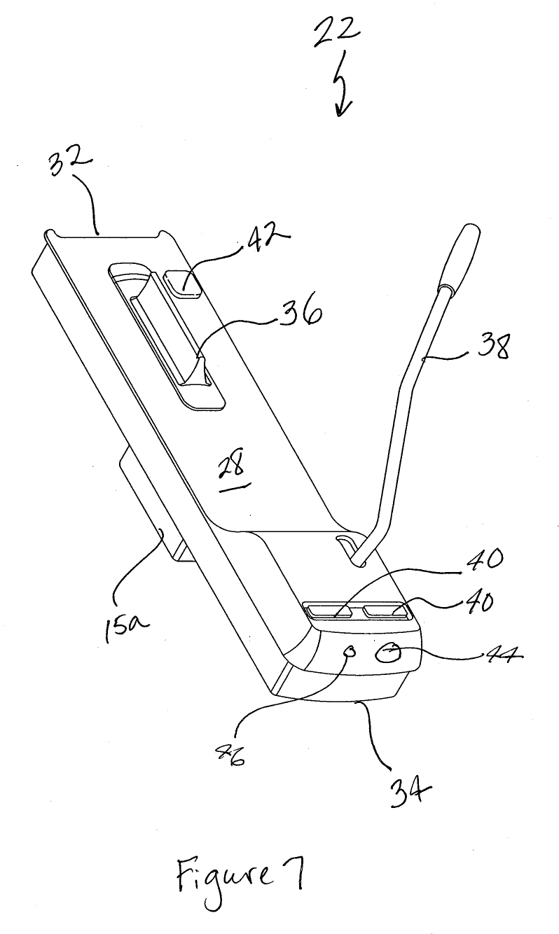

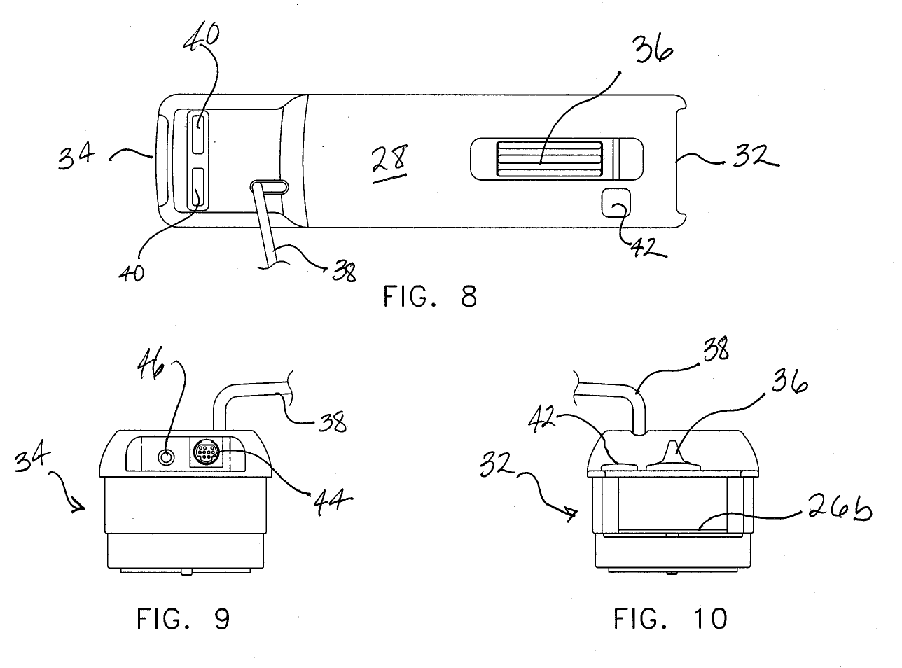

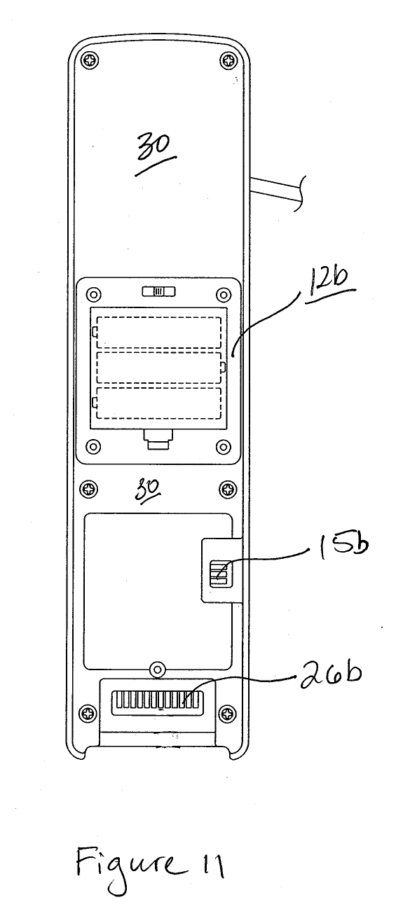

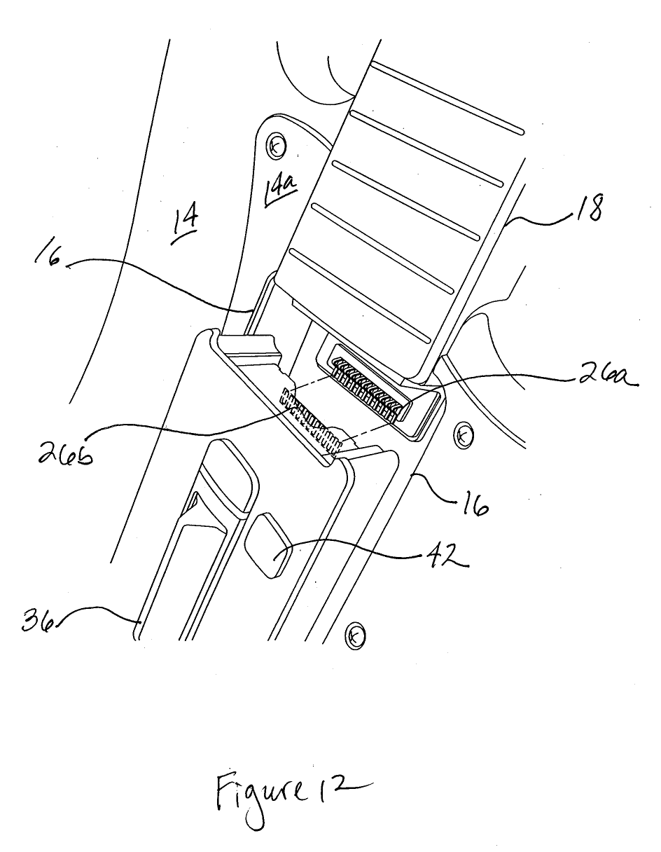

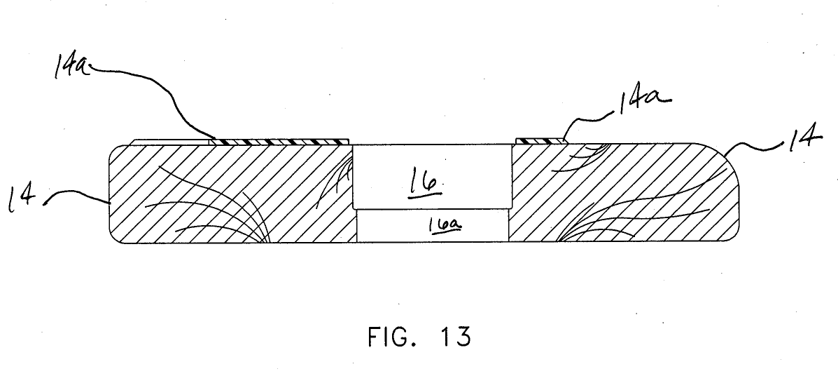

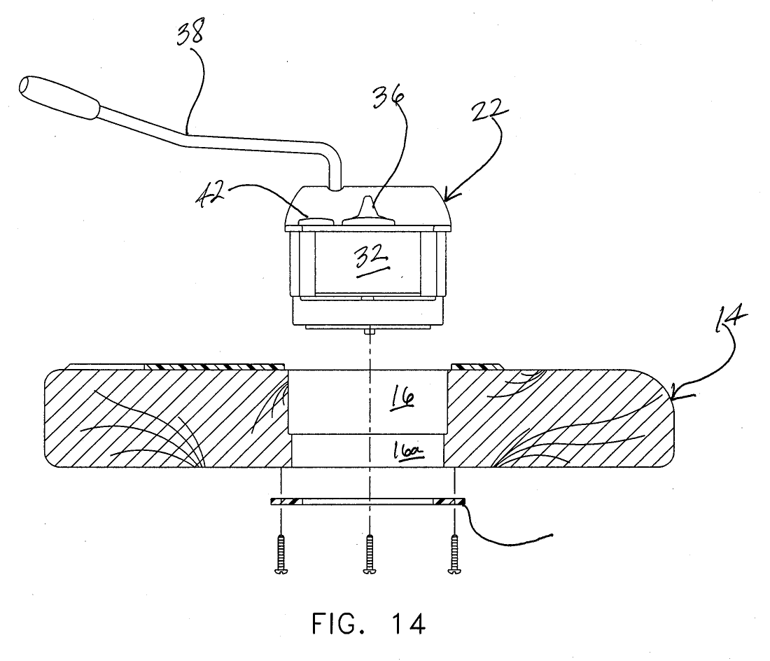

FIGS. 1-15, when taken together, illustrate an exemplary video game device 10 (hereinafter “device 10”). As shown, device 10 is configured and dimensioned in the shape of a guitar, but it should be understood that the concepts disclosed herein are not limited to guitars or musical instruments in general, and that they can be applied to a variety of musical instruments and/or game platforms.

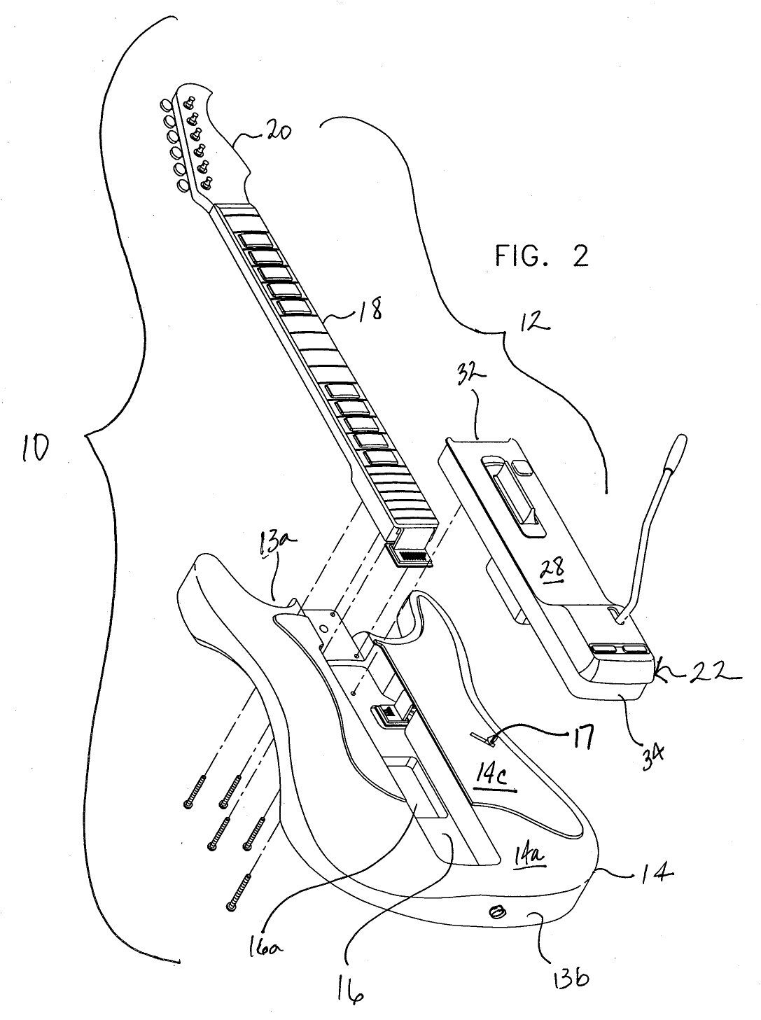

As shown in FIG. 2, in the present exemplary embodiment, device 10 comprises a controller subassembly 12 (hereinafter subassembly 12) and a body 14 with opposing front and back surfaces 14a,b, and opposing top and bottom ends 13a,b.

With reference to FIGS. 2, 5 and 6, body 14 comprises a region 16 configured and dimensioned to receive and electrically couple with subassembly 12 or a portion of subassembly 12, and can be connected thereto with a variety of fasteners such as screws, pins, rivets, clamps, and the like. In the present embodiment, region 16 is recessed in body 12, and comprises an opening 16a extending through the back surface 14b. Disposed in recessed region 16 is a connector 15 for coupling to effect selector switch 17. Body 14 and recessed region 16 can comprise any shape, size, material and/or configuration, provided that recessed region 16 is configured to receive subassembly 12 or a portion of subassembly 12 therein. In the present exemplary embodiment, the body, and the back of the neck and the headstock are made out of wood, but it should be understand that a variety of materials may be used including, for example, composites, plastics, and the like. If desired, body 14 can comprise a simulated pick guard 14c of a contrasting color disposed on the front of the body. A cover 12b (See FIG. 11) is disposed at the back of the body 14, corresponding to opening 16a, to access batteries (shown in phantom) disposed in the controller 22. Although region 16 is illustrated herein as a recessed region, it should be understood that it is not necessary for region 16 to be recessed, and that subassembly 12 or a portion of subassembly 12 can be coupled to body 14 in a variety of ways. For example, region 16 can be coplanar with upper surface 12a of body 12, or it can comprise a raised region corresponding to the subassembly 12, and the like.

As shown in FIG. 2, subassembly 12 comprises a neck 18, a headstock 20 disposed at one end of the neck 18, and a controller 22 disposed at an opposite end of the neck 18. As shown, neck 18, headstock 20 and controller 22 comprise separate, interconnected pieces, but it should be understood that any two or more of the pieces can be integrated, if desired, or that the entire subassembly 12 can comprise a single, unitary piece.

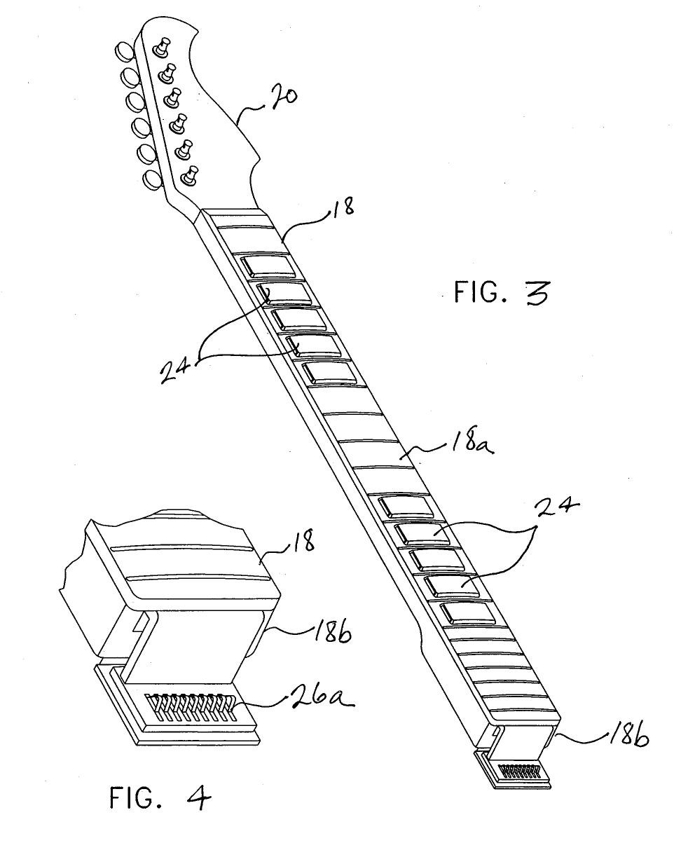

As shown in FIGS. 3 and 4, neck 18 comprises a front surface 18a and a base end 18b. Disposed on front surface 18a are a plurality of keys 24, adapted to simulate guitar chords. A connector 26a is disposed at the base 18b, for electrically coupling to a corresponding connector 26b, disposed on the controller 22.

As shown in FIGS. 2 and 7-11, controller 22 is configured and dimensioned to be received into recessed region 16 of body 14. That is, controller 22 comprises a generally longitudinal shape and thickness corresponding to the shape and depth of the recessed region 16. Controller 22 comprises opposing front and back surfaces 28,30 and opposing upper and lower ends 32,34. Connector 26b is disposed at upper end 32 of controller 22 for coupling with connector 26a on neck 18. Connector 15b is disposed on the backside of controller 22 for detachably coupling with connector 15a in body 14, and thereby to the effect sensor switch 17.

Disposed on the front surface of the controller 22 are various optional actuation devices including a strumming device 36, in the place where a player would normally strum the strings, a whammy bar 38, and a variety of functional buttons 40. Optionally, controller 22 can comprise a special function actuator 42 dedicated to actuating “special” functions, disposed adjacent to (e.g, ⅛ inch to about 1 inch) to the strum device 36 for ease of actuation. Alternatively, or in addition to, special function actuator 42 can be mounted in an area for easy access by the opposite hand. In the present exemplary embodiment, special function actuator 42 is illustrated as a button, but it should be understood that various types of actuators can be used, including mechanical, electrical and/or various types of sensors (e.g., optical, capacitative, pressure, and the like). Various inputs 44, 46 are disposed at lower end 34 of controller 22 for coupling with various devices and/or game console (not illustrated) and/or to an external power source (not illustrated).

All electrical input and outputs are made to sub-assembly 12, enabling it to be used without body 14, and to be used interchangeably with other bodies comprising different gaming platforms. Thus, sub-assembly 16 can be used interchangeably with a variety of bodies, provided that they comprise a corresponding recessed region 16, and body 12 can be used interchangeably with a variety of subassemblies 12, provided that they are configured and dimensioned to correspond to the recessed region 16 of the body 12. This enhances manufacturing flexibility, including the ability to easily change body styles and/or gaming platforms. Electronics, switches, wiring, etc. can be disposed in hollow regions (not illustrated) in the guitar body and neck.

Subassembly 16 can also be configured so that the controller 22 can be interchanged with alternate controllers having the same configuration, in order to allow use with the body. The alternate controllers could also be different in shape in order to accommodate different electronics, sensors or interface methods. Alternate controllers could, for example, provide compatibility with alternate game systems or provide a path for future upgrades. All controllers can comprise the same mating connectors with a standardized position and orientation to facilitate modularity.

Controller 22 also can be removed from the device 10 without detaching the subassembly 12. Thus, the user can easily replace the controller 22, or interchange the controller 24 for one with another video game platform. To facilitate detachment, a connector 26a,b can be disposed between the controller 22 and the neck 18. It should be understood that a variety of connectors can be used to connect the various pieces of the sub-assembly together with each other and/or to the body, which would be known in the art.

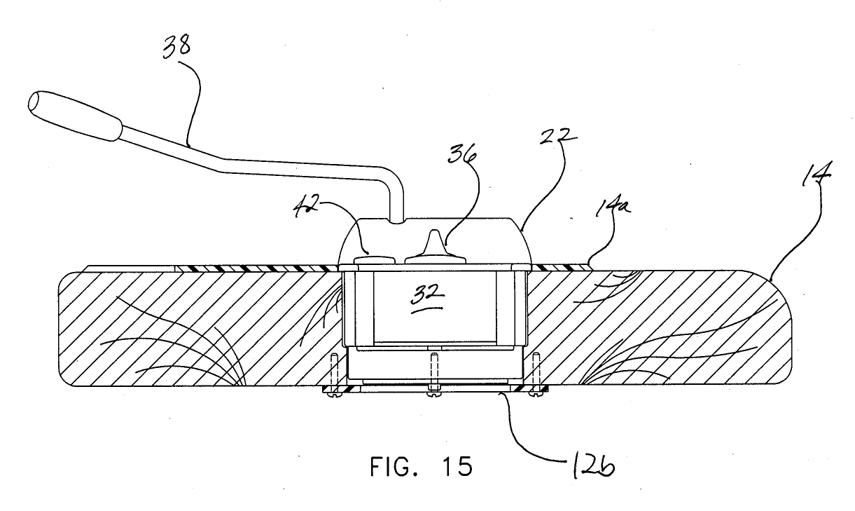

FIGS. 16-24, when taken together, illustrate another aspect of the disclosure. As shown, device 100 comprises a detection region 48 that can comprise one or more sensors.

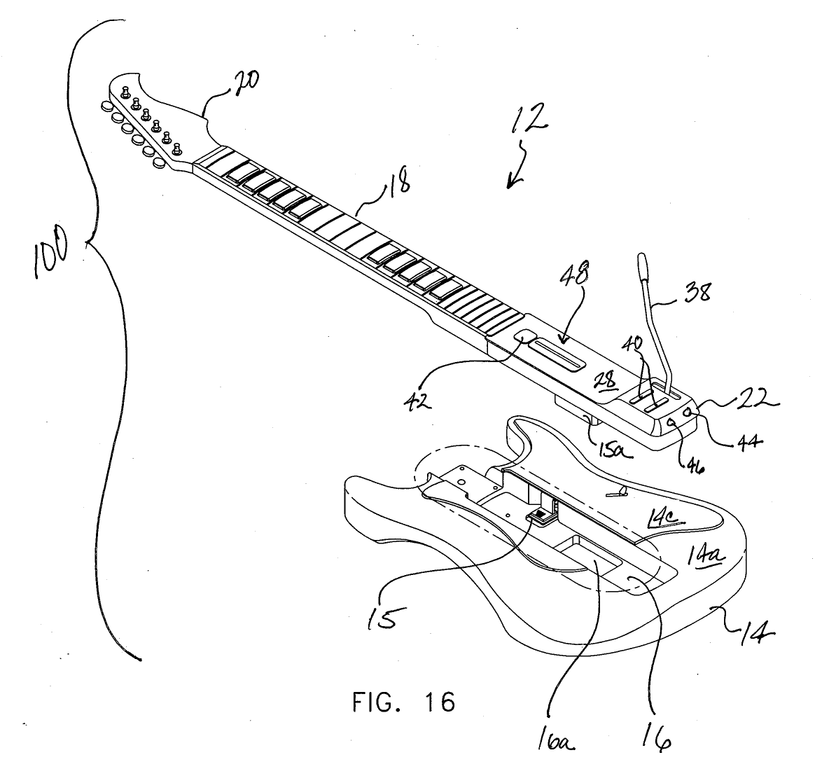

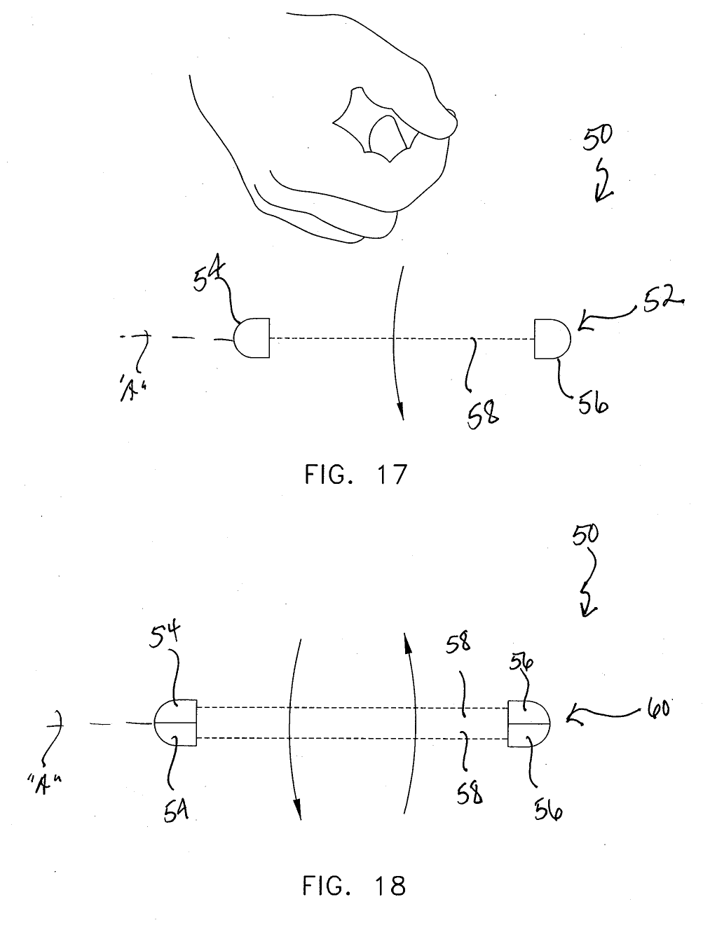

FIG. 17 shows one embodiment of device 100 comprising an optical strum sensor 50. In the present embodiment, optical strum sensor 50 comprises one or more optical sensors 52, each comprising a spaced apart photo-emitter 54 (hereinafter “emitter”) and photo-receiver 56 (hereinafter “receiver”). The spacing between emitter 54 and receiver 56 can be varied. In the present exemplary embodiment, emitter 54 and receiver 56 are spaced apart by about 3 inches. Optical sensors 50 can detect objects even in high ambient light conditions, allowing use during daytime or in the presence of relatively bright lights. In use, a light signal 58 is emitted from emitter 54 and directed at receiver 56. When the light signal 58 from emitter 54 to receiver 56 is interrupted, controller 24 can trigger an action in the game. The signal 58 can be interrupted by, for example, an object that is not transparent to the light emitted by the emitter 54 directed between the emitter 54 and receiver 56. For example, as shown, the hand of a user strumming the guitar can interrupt the light signal 58, which can trigger an action in the game.

FIG. 18 shows another embodiment of the optical strum bar 50, comprising a pair 60 of spaced apart emitters 54 and receivers 56. The spacing between emitters 54 and receivers 56 can be varied, and in the present exemplary embodiment, the spacing is about 3 inches. The use of pair 60 is the same as in the previous embodiment, and can be used to detect the sequence of actuation of the sensors, from which the direction of strumming can be detected. Alternatively, the time delay between the interruptions of the two light signals can be monitored and used to provide additional functions. For example, when the speed between interruptions of the two light signals increases, it can trigger an increase in volume and/or another game function.

FIG. 19 shows another exemplary embodiment, comprising a Hall-effect sensor “A” (hereinafter “Hall sensor”), which can be adapted to trigger specific functions. When a magnetized object 62 is brought close to the sensor A, the sensor detects a change in the magnetic field, which can cause the controller to trigger an action in the game. The Hall sensor can detect a magnetized object 62 within a radius of approximately 0.5 inches from the sensor, depending on the sensitivity, although other distances are possible with stronger magnets and higher quality sensors. The Hall sensor can be actuated by disposing the hand-held magnetized object sufficiently close to the sensor, which allows the object to be detected. Disposing the magnetized object farther away from the sensor can prevent triggering when not desired, or accidental triggering.

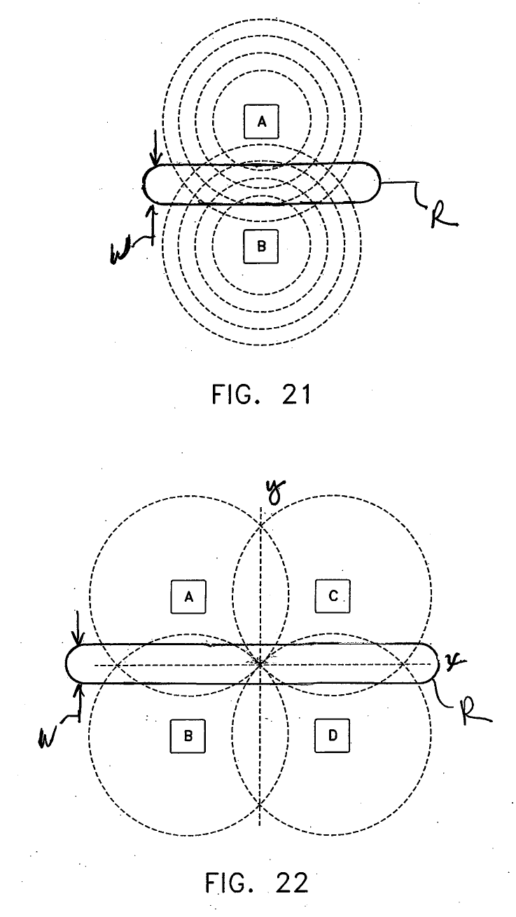

More than one Hall-effect sensor can be positioned in a linear grid array (FIG. 21) or an orthogonal grid array (FIG. 22) to provide additional position resolution. To simulate strumming a guitar string, the detection zone optimally can be linear, like a string. This allows a user's hand to hover near the detection zone and to cross it in either direction with a short motion roughly perpendicular to the detection zone, reducing the number of accidental triggers.

FIG. 21 shows another exemplary embodiment comprising a linear grid array of two Hall-effect sensors “A” and “B.” As shown, sensors A and B are positioned so that their detection zones (concentric circles shown in phantom) overlap in region “R.” As a magnetized object is moved across the array, the output signal of each sensor is proportional to its distance from the object. The two output signals can be monitored, and when the signals are equal (Va=Vb), a trigger signal can be sent by the software.

The region in which the signals are equal is roughly linear. The width “w” of the linear detection zone 66 can be adjusted in software by changing the conditions under which a trigger signal can be sent. For example, Va−Yb=0 satisfies the state at which both signals are equal. The equation Va−Vb=0+1−1 allows any result from −1 to +1 to send a trigger signal. Software can also prevent multiple trigger signals by inserting a time delay before another trigger signal can be sent, or by comparing sequential results. If the result is increasing in voltage, it can indicate a single strum in one direction. If the result is decreasing in voltage, it can indicate a single strum in the opposite direction. This directional sensitivity is an additional benefit of using multiple sensors.

FIG. 22 shows another exemplary embodiment comprising an orthogonal gird array of four Hall-effect sensors A, B, C and D. To create a horizontal linear detection zone R as shown, the output of sensor A is compared to sensor B, and the output of sensor C is compared to sensor D. The additional pair of sensors effectively lengthen the detection zone, making it easier for the user to actuate. The software monitors the sensor pairs as described above. Depending on where the user crosses the linear detection zone, one pair, the other pair, or both pairs of sensors may be actuated. Like the two sensor embodiment, the width “w” of the linear detection zone can be modified to adjust sensitivity.

As shown in FIG. 23, the orthogonal array of four sensors can also be used to detect movements in the y-axis, as described above, and also in the x-axis, by comparing the signals of different sensors. To create a linear detection zone “P” perpendicular to R in the previous embodiment, the output of sensor A is compared to sensor C, and the output of sensor B is compared to sensor D. By extension, both directions can be monitored simultaneously, enabling detection of the x and y-axis position of the magnetized object within the array.

The above illustrations show a two-dimensional case. However, it should be understood that the detection can occur at a limited distance in the z-axis (into and out of the page). This enables the user to strum at different heights, while still triggering the device. The maximum amplitude of the signals can be monitored, and a secondary signal can be generated by the software. For example, strumming at different distances from the sensor plane can correspond to volume or some other function of the game.

Hall-effect sensors can be actuated by a magnet when the magnet poles are in a suitable orientation. However, properly oriented magnets can be mounted in close proximity to each Hall sensor. In this way, the user can use any ferrous object to actuate the sensors. The orientation of the ferrous object is unimportant.

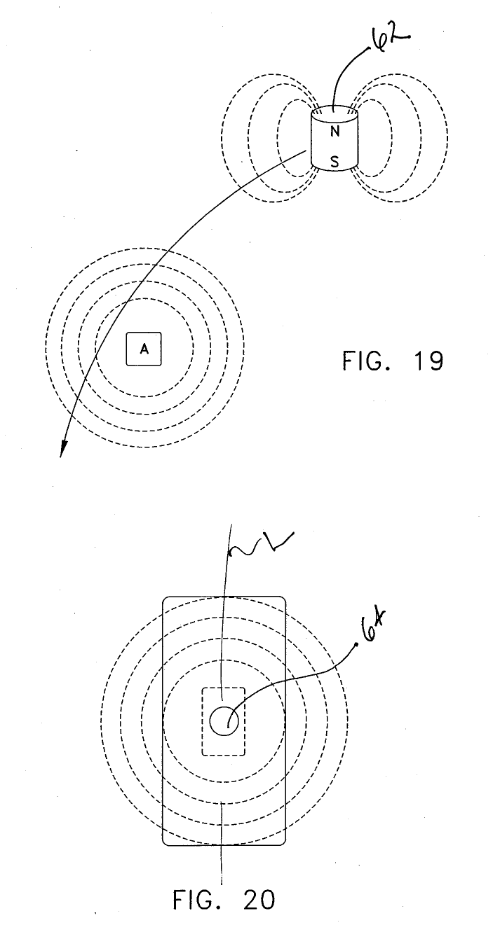

As shown in FIG. 20, to facilitate accurate strumming, an optional ridge or raised region 64 can be disposed along the axis “L” of the linear detection zone of the emitter/receiver pairs. Also optionally, strings like a guitar can be mounted adjacent to the emitter/receiver pairs, to simulate the feel of a regular guitar. As noted above, multiple sensors can be included if additional functionality in the game controller is desired.

Capacitative sensors are responsive to the presence of certain materials within range of detection, such as a user's hand or finger. Capacitative sensors can be used in device 100 singly and/or or in any of the arrangements described above, to trigger the performance of specific functions. They can also work through a thin plastic or glass membrane.

Similarly, pressure sensors are responsive to pressure, such as by a user's hand or finger. Pressure sensors can be used in device 100 singly and/or or in any of the arrangements described above, to trigger the performance of specific functions. They can also work through a thin plastic or glass membrane.

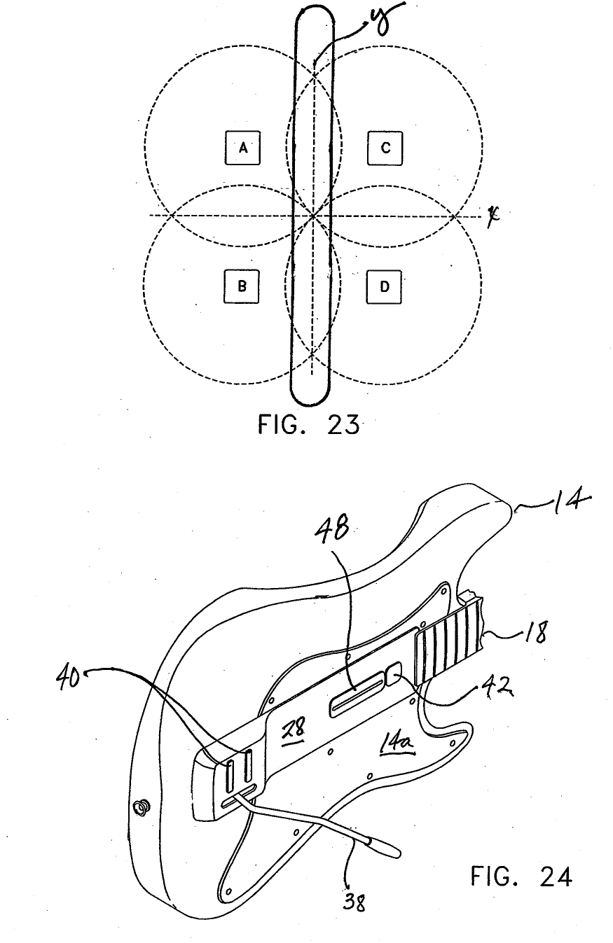

As shown in FIG. 24, device 100 can also comprise a special function actuator 42 dedicated to actuating “special” functions, which can be mounted in close proximity to detecting region 48 for quicker actuation. Optionally, special function actuator 42 can be mounted in any area for easy access by the opposite hand. In the present exemplary embodiment, special function actuator 42 is illustrated as a button, but it should be understood that any of the sensors described above can be used.

Video game devices according to the present disclosure can be advantageous because they provide functional advantages compared to existing devices.

Throughout the application, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. Unless defined otherwise, technical and scientific terms used herein have the same meaning as is commonly understood by one of skill in the art to which this disclosure belongs. The modifier “about” used in connection with a quantity is inclusive of the stated value and has the meaning dictated by the context (e.g., includes the degree of error associated with measurement of the particular quantity). The terms “bottom” and “top” are used herein, unless otherwise noted, merely for convenience of description, and are not limited to any one position or spatial orientation.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of any appended claims.

What is claimed is:

1. A video game device, comprising:
an electronic subassembly comprising a controller, the controller comprising a selected video game platform adapted to interface with a game console;
a body comprising a region configured and dimension to receive at least a portion of the controller;
at least one game actuator device electrically coupled to the controller and adapted to trigger a gaming action upon actuation; and
a source of power disposed in the controller.

2. The video game device of claim 1, wherein the electronic subassembly is detachably connected to the body.

3. The video game device of claim 1, wherein the controller is detachably connected to the body.

4. The video game device of claim 1, wherein the body comprises a guitar body and the electronic subassembly comprises a neck detachably coupled to the controller and a head detachably coupled to the upper end of the neck.

5. The video game device of claim 4, further comprising:
a detecting region disposed on the body; and
one or more sensors disposed in the detecting region and coupled to the controller;
wherein the one or more sensors are adapted to trigger a gaming action upon actuation.

6. The video game device of claim 5, wherein the one or more sensors are selected from the group consisting of light sensors, transducers, capacitative sensors, pressure sensors, and combinations thereof.

7. The video game device of claim 5, further comprising a strum bar disposed at the detecting region and a special function actuation device disposed adjacent to the strum bar.

8. The video game device of claim 1, wherein the region is recessed.

9. A video game device, comprising:
an electronic subassembly comprising a controller, the controller comprising a selected video game platform adapted to interface with a game console;
a body comprising a region configured and dimension to receive at least a portion of the controller;
at least two spaced apart sensors electrically coupled to the controller and defining a detecting region, the at least two spaced apart sensors adapted to trigger a gaming action upon interruption of a signal between the at least two spaced apart sensors; and
a source of power disposed in the controller.

10. The video game device of claim 9, further comprising a raised region disposed between the at least two spaced apart sensors.

11. The video game device of claim 9, wherein the at least two spaced apart sensors comprise an optical sensor.

12. The video game device of claim 11, wherein the optical sensor comprises a photo-emitter spaced apart from a photo-receiver.

13. The video game device of claim 12, wherein the optical sensor comprises a pair of photo-emitters spaced apart from a pair of photo-receivers.

14. The video game device of claim 13, wherein the controller is adapted to trigger a gaming action upon actuation of the pair.

15. The video game device of claim 13, wherein the controller is adapted to determine the direction of a user's strumming motion from the signals generated by the pair of photo-emitters.

16. The video game device of claim 9, wherein the at least two spaced apart sensors comprise Hall effect sensors.

17. The video game device of claim 9, wherein the region is recessed.

18. A video game device, comprising:
an electronic subassembly comprising a controller, the controller comprising a selected video game platform adapted to interface with a game console;
a body comprising a region configured and dimension to receive at least a portion of the controller;
a strum bar;
a special function actuation device disposed on the controller; and
a source of power disposed in the controller.

19. The video game device of claim 18, wherein the special function actuation device is disposed adjacent to the strum bar.

20. The video game device of claim 18, wherein the special function actuation device is spaced apart from the strum bar by about ⅛ inch to about 1 inch.

21. The video game device of claim 18, wherein the region is recessed.
